(19) United States
(12) Patent Application Publication
(10) Pub. No.: US 2011/0145370 A1
(43) Pub. Date: Jun. 16, 2011

(54) METHODS AND SYSTEMS TO PERSONALIZE CONTENT STREAMS

(76) Inventor: Bruno Nieuwenhuys, Bucharest (RO)

(21) Appl. No.: 12/873,035

(22) Filed: Aug. 31, 2010

Related U.S. Application Data
(60) Provisional application No. 61/238,441, filed on Aug. 31, 2009.

(51) Int. Cl. G06F 15/16

(52) U.S. Cl. 709/219

(57) ABSTRACT

Methods and systems to insert secondary content within a primary audio and/or video stream in real-time. Insertion may be implemented as a continuous process and/or on-demand, and may be implemented independent of content provider and content consumer platform technologies. Insertion may be implemented transparent to content providers and content consumers. Secondary content may include personalized content, which may be personalized with respect to an individual and/or a group of individuals. Secondary content may include personalized advertising content. A media stream may be monitored and inspected and to determine where to place personalized content.

### BACKGROUND

Audio and video streams across the Internet deliver various forms of media content for a variety of purposes, such as entertainment, business, research and development. As with more conventional forms of media content delivery, it may be desirable to insert secondary content, such as personalized advertising, into a primary media content stream.

Conventional personalized content delivery systems include media stream switching, in which a primary content stream is switched to a secondary stream to deliver alternative content. Media stream switching is technology dependent and requires starting, stopping and buffering the streams, which may result in undesirable silences or delay during switching.

Conventional personalized content delivery systems include altering of a playback or playlist. This, however, requires primary content providers to include the secondary content in the playlist and to have the secondary content available at a content setup stage.

### BRIEF DESCRIPTION OF THE DRAWINGS/FIGURES

FIG. 1 is a block diagram of an exemplary content streaming environment, including a personalized content system.

FIG. 2 is a process flowchart of an exemplary method of inserting secondary content into a primary media content stream.

FIG. 3 is a block diagram of an exemplary computer system.

In the drawings, the leftmost digit(s) of a reference number identifies the drawing in which the reference number first appears.

### DETAILED DESCRIPTION

Disclosed herein are methods and systems to insert secondary content within a primary audio and/or video stream, in real-time. Insertion may be implemented as a continuous process and/or on-demand, and may be implemented independent of content provider and content consumer platform technologies. Insertion may be implemented transparent to content providers and content consumers.

Secondary content may include personalized content, which may be personalized with respect to an individual and/or a group of individuals. Secondary content may include personalized advertising content.

A media stream may be monitored and inspected and to determine where to place personalized content.

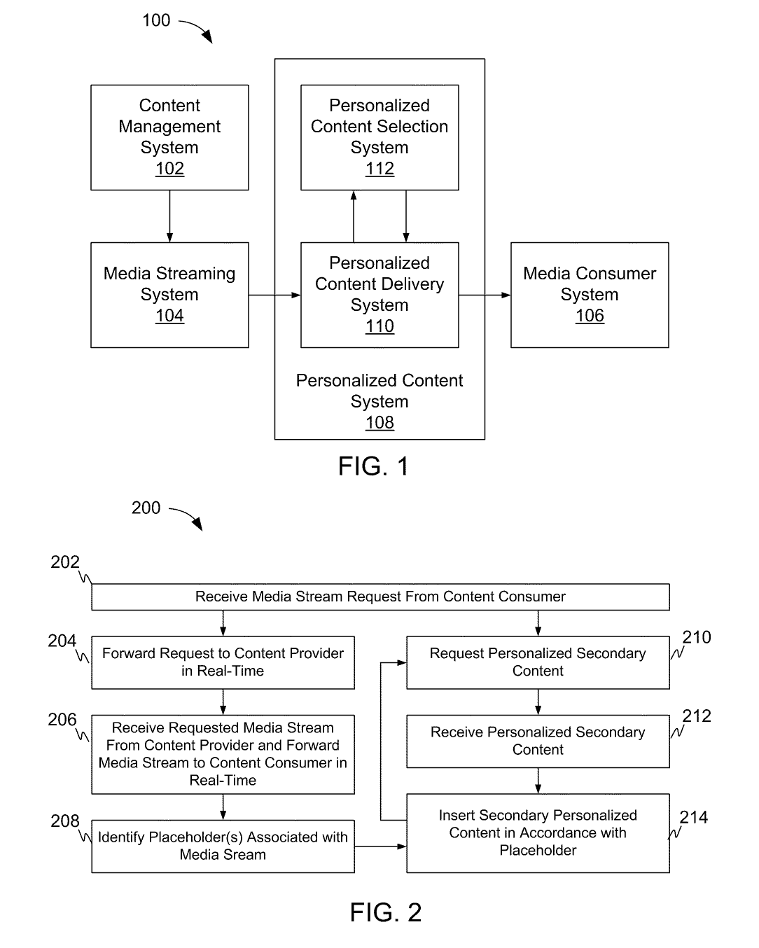

FIG. 1 is a block diagram of an exemplary media streaming environment 100.

Environment 100 may include a content management system 102 to manage a primary media content stream. Content management system 102 may be configured to define media content to be delivered. Content management system 102 may include, for example, one or more of a WinMedia and a RBS system.

Environment 100 may include a media streaming system 104 to stream media content to a media consumer system 106. Media streaming system 104 may correspond to, for example, one or more of a Shoutcast, an Icecast, a Wowza, and a Windows Media system. Media streaming system 104 may be configured to modify a source media stream to deliver different qualities of a media stream to one or more media consumer systems 106.

Media consumer system 106 may include one or more of a variety of systems, such as, for example and without limitation, a personal computer, a handheld wireless communication device, and a game device.

Environment 100 includes a personalized content system 108, which may include a personalized content delivery system 110 to insert secondary content into one or more media streams, transparent to content management system 102, media streaming system 104 and media consumer system 106.

Personalized content system 108 may include a personalized content selection system 112 to select personalized content and to provide the personalized content to personalized content delivery system 110. Personalized content selection system 112 may be configured to retrieve secondary content from one or more secondary content provider systems, such as an advertiser system.

Content management system 102 may be configured to define one or more personalized content delivery points associated with the media content and/or a media stream. Exemplary personalized content delivery point definitions are provided below. The disclosure is not, however, limited to the exemplary definitions herein.

A content delivery point may be defined as a placeholder in a source media.

A content delivery point may be defined as, or with respect to a placeholder at a particular position within content programming or a media file.

A placeholder may be defined as one or more particular frames within a media file.

A placeholder may be defined as one or more time intervals.

A placeholder may include an acoustic marker.

A placeholder may include or correspond to programming data within the source media.

A placeholder may include or correspond to one or more files inserted in the content programming system, such as metadata. A tool may be used to place a placeholder or a corresponding file directly into the media.

Table 1 provides exemplary placeholders and corresponding information.

TABLE 1
Exemplary Placeholders

| Placeholder Type | Where | Example | Action Examples |
|---|---|---|---|
| File frame | Inside file held by | Frame number | Deliver |
| | Content | | personalized |
| | Programming | | content ‘here’ for a |
| | System | | pre-set duration |
| Meta Data | Inside file held by | addtrack_<<duration>> | delivers |
| | Content | | personalized |
| | Programming | | content for |
| | System | | <<duration>> |
| | | addtrack_stop | Marks end of |
| | | | personalized |
| | | | content |
| Audible decorator | Inside file held by | ‘#’ # = number between 1-9 | Deliver |
| | Content | | personalized |
| | Programming | | content ‘here’ for a |
| | System | | pre-set duration |
| | | 0 | Marks end of |
| | | | personalized content |

Exemplary operation of environment 100, including personalized content system 108 is described below with respect to FIG. 2.

FIG. 2 is a process flowchart of an exemplary method 200 of inserting secondary content into a primary media content stream. Method 200 is described below with respect to FIG. 1. Method 200 is not, however, limited to the example of FIG. 1.

At 202, media consumer system 106 initiates or requests a media content streaming session with respect to media streaming system 104.

At 204, the initiation or request is received at personalized content delivery system 110 and forwarded to media streaming system 104. The request may be forwarded synchronously. Personalized content delivery system 110 may capture media session data, which may include one or more of a cookie, a header, such as an HTTP header, and internet protocol (IP) information, associated with media consumer system 106 and/or a user thereof.

Personalized content system 108 may effectively act as a network router or switch.

Alternatively, media consumer system 106 may connect directly to media streaming system 104.

At 206, media content is streamed from media streaming system 104 to media consumer system 106, through personalized content delivery system 110.

At 208, personalized content delivery system 110 may identify placeholders and/or placeholder rules associated with the media stream.

At 210, personalized content delivery system 110 may request secondary or personalized media content from personalized content selection system 112. Personalized content selection system 112 may respond with media content that is personalized or otherwise relevant to a user associated with the request received at 202. The request for personalized media content at 210 may be performed asynchronously with respect to the forwarding of the request at 204, the receiving and forwarding of the media stream at 206, and the identifying placeholders at 208.

At 212, personalized media content is returned by personalized content selection system 112. Personalized content selection system 112 may retrieve the personalized media content, or a portion thereof, from one or more other system that may be remote from personalized content selection system 112.

Personalized content system 108 may check or verify one or more content delivery rules, such as age, targeting rules, such as male/female, geo-location rules, such as country or city, and may retrieve the personalized media content, or a reference to a series of personalized media content, in preparation for delivery or insertion in real-time.

At 214, personalized content delivery system 110 delivers or inserts the personalized content received at 212 within the media stream and in accordance with the placeholder(s) identified at 208.

Personalized content delivery system 110 may intelligently monitor and inspect the media stream at 208 to identify when the delivery of personalized media content is required, and may deliver and/or insert the personalized media content at 214 as soon as a personalized content delivery placeholder or interval is identified.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

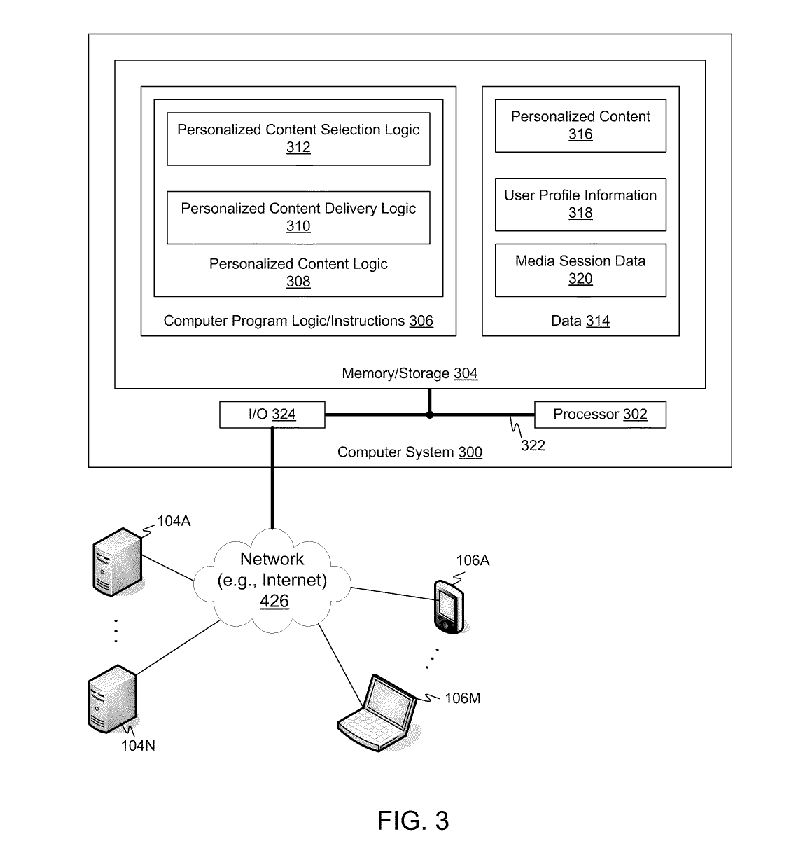

FIG. 3 is a block diagram of an exemplary computer system 300, including one or more computer instruction processing units, illustrated here as a processor 302, to execute computer program product logic, also known as instructions, code, and software.

Computer system 300 includes memory/storage 304, including a computer readable medium having computer program product logic or instructions 306 stored thereon, to cause processor 302 to perform one or more functions in response thereto.

Memory/storage 304 further includes data 314 to be used by processor 302 in executing instructions 306, and/or generated by processor 302 in response to execution of instructions 306.

In the example of FIG. 3, logic 306 includes personalized content logic 308, which may include personalized content delivery logic 310 to cause processor 302 to receive media content requests from one or more media consumer systems 106, to forward the requests to one or more media streaming systems 104, to forward streaming media from media streaming systems 104 to media consumer systems 106, and to insert secondary or personalized content 316 into the media streams, such as described in one or more examples above.

Personalized content logic 308 may include personalized content selection logic 312 to cause processor 302 to retrieve personalized content 316 from data 314 and/or from one or more external sources, in response requests generated under control of personalized content delivery logic 310.

Data 314 may include user profile information 318 to be used by processor 302 to identify suitable personalized content 316, and or to generate requests for suitable personalized content 316. User profile information 318 may be associated with individual users through media session data 320, which may correspond to one or more of login identification, a cookie, a header, such as an HTTP header, and internet protocol (IP) information.

Computer system 300 may include a communications infrastructure 322 to communicate amongst components of computer system 300.

Computer system 300 may include an input/output controller 324 to communicate with media streaming systems 104A through 104N and media consumer systems 106A through 106M, over a network 426, such as the Internet.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

One skilled in the art will recognize that these functional building blocks can be implemented by discrete components, application specific integrated circuits, processors executing appropriate software, and combinations thereof.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A system, comprising:
a content delivery system to receive a media content request from a media consumer system, to identify a user from the request, to forward the request to a media streaming system, to request personalized media content corresponding to the user, to receive streaming media from the media streaming system and to forward the streaming media to the user, to identify a placeholder associated with the streaming media, and to insert the personalized media content in the media stream in accordance with the placeholder in real-time.

2. The system of claim 1, wherein the content delivery system is implemented independent of the media streaming system and the media consumer system.

3. The system of claim 1, wherein the content delivery system is configured to identify the placeholder within the streaming media.

4. The system of claim 1, wherein the content delivery system is configured to identify the placeholder as a position within the streaming media.

5. The system of claim 1, wherein the content delivery system is configured to identify the placeholder as one or more frames within the streaming media.

6. The system of claim 1, wherein the content delivery system is configured to identify the placeholder as a time interval within the streaming media.

7. The system of claim 1, wherein the content delivery system is configured to identify the placeholder as an acoustic marker within the streaming media.

8. The system of claim 1, wherein the content delivery system is configured to identify the placeholder with respect to data within the streaming media.

9. The system of claim 1, wherein the content delivery system is configured to identify the placeholder from meta data of the streaming media.

10. A method, comprising:
receiving a media content request from a media consumer system;
identifying a user from the request;
forwarding the request to a media streaming system;
requesting personalized media content corresponding to the user;
receiving streaming media from the media streaming system and forwarding the streaming media to the user;
identifying a placeholder associated with the media stream; and
inserting the personalized media content in the media stream in accordance with the placeholder in real-time;
wherein the receiving, the identifying, the forwarding, the requesting, the receiving, the identifying, and the inserting are performed in a suitably programmed computer system.

11. The method of claim 10, further including performing the receiving, the identifying, the forwarding, the requesting, the receiving, the identifying, and the inserting independent of the media streaming system and the media consumer system.

12. The method of claim 10, further including identifying the placeholder within the streaming media.

13. The method of claim 10, further including identifying the placeholder as a position within the streaming media.

14. The method of claim 10, further including identifying the placeholder as one or more frames within the streaming media.

15. The method of claim 10, further including identifying the placeholder as a time interval within the streaming media.

16. The method of claim 10, further including identifying the placeholder as an acoustic marker within the streaming media.

17. The method of claim 10, further including identifying the placeholder with respect to data within the streaming media.

18. The method of claim 10, further including identifying the placeholder from meta data of the streaming media.

19. A computer program product including a computer readable medium having computer program logic stored therein, the computer program logic comprising:
logic to cause a processor to receive a media content request from a media consumer system;
logic to cause the processor to identify a user from the request;
logic to cause the processor to forward the request to a media streaming system;
logic to cause the processor to request personalized media content corresponding to the user;
logic to cause the processor to receive streaming media from the media streaming system and forwarding the streaming media to the user;
logic to cause the processor identify a placeholder associated with the streaming media; and
logic to cause the processor to insert the personalized media content in the streaming media in accordance with the placeholder in real-time.

20. A system, comprising:
means for receiving a media content request from a media consumer system;
means for identifying a user from the request;
means for forwarding the request to a media streaming system;
means for requesting personalized media content corresponding to the user;
means for receiving streaming media from the media streaming system and forwarding the streaming media to the user;
means for identifying a placeholder associated with the streaming media; and
means for inserting the personalized media content in the streaming media in accordance with the placeholder in real-time.
